(19) United States
(12) Patent Application Publication
(10) Pub. No.: US 2009/0308035 A1
(43) Pub. Date: Dec. 17, 2009

(54) Optimization of cellular structures especially for exhaust-gas cleaning of combustion assemblies and other fields of application

(75) Inventors: Elke Bauer, Holzwickede (DE); Ottmar Kryts, Bad-Nauheim (DE)

Correspondence Address: DeMont & Breyer, LLC, 100 Commons Way, Ste. 250, Holmdel, NJ, 07733, US

(73) Assignee: Bauer Technologies GmbH, Hoehr-Grenzhausen (DE)

(21) Appl. No.: 12/300,576

(22) PCT Filed: May 14, 2007
(86) PCT No.: PCT/EP2007/004259

§ 371 Date: Mar. 24, 2009

(30) Foreign Application Priority Data
May 15, 2006 (DE) 20 2006 007 876.2

(51) Int. Cl. B01D 29/00; B32B 3/26

(52) U.S. Cl. 55/522; 428/304.4

(57) ABSTRACT

The invention relates to a device through which a fluid can flow and that has a cellular structure, a system for modular optimization of cellular structures, and also a method for producing such structures.

The device through which a fluid can flow comprises a working range with a cellular structure. The cellular structure has a shape and/or dimensions such that, with respect to a monolithic device with at least two channels that have a rectangular cross section, the thermal conductivity is greater and/or the flow resistance is lower and/or the mechanical resistance, in particular, the compressive and/or tensile resistance, is higher and/or the temperature stability is higher.

The invention relates to a device with a cellular structure through which fluid can flow, a system for modular optimization of cellular structures, and also a method for producing such structures.

In the combustion of fossil fuels, especially for propulsion technology, in the last 10 years the environmental understanding has changed to the extent that merely the optimization of internal engine combustion does not represent an adequate effect to deplete the flowing fluids, that is, the exhaust gases loaded with particles or the particulate volume flows of the exhaust gases in such a way that they can be tolerated by the environment. With the introduction and institutionalization of catalytic converters, a first step was made for gaseous materials. For a few years, the filtration of solids-bearing exhaust gas flows has also been at the center of technological developments. Here, in the filtration of particles, because the first actual long-term results are becoming known, this technology is in the verification phase. In subsequent generations of particulate filters, the problems of particulate filter systems used in the meantime in large-scale production and their existing initial deficiencies will be treated.

As a representative for all types of combustion exhaust-gas flows with a particulate load, here the problems and solutions are described with respect to particulate filter elements for diesel fuel combustion engines, wherein the illustrated system solutions also apply both for liquid fuels and gaseous fuels, and naturally also for solid fuels or their combinations.

All types of combustion have in common that a more or less high concentration of solid particles is contained in the gaseous exhaust-gas volume flow, wherein these solid particles originate either from non-combustible components, usually impurities, in the fuel or else from incomplete combustion processes, for the most part soot, or from the systems of the catalyst of the purification processes, the so-called additives, or from their combinations. However, additional components of solid flows in the exhaust-gas flows are also wear components of the combustion systems themselves.

The essential, but not exclusive categories of particulate-loaded combustion assemblies here are passenger cars, utility vehicles, mobile or stationary work machines, rail or water propulsion machines, and assemblies for heating or power generation, such as household heating systems, industrial heating and power plants, and turbine or jet engines of all types, to name only a sample of possible assemblies.

According to the state of the art, generally known monolithic catalytic converters, for the most part made from metal or ceramic, typically have a catalytic coating for the purification of the gaseous combustion products; their flow principle is the blowby flow of exhaust-gas volume flows past the walls of the monolith and the conversion of the gases on this monolith. For the filtration of particles, according to the current state of the art, wall filtration through porous walls in monolithic filter elements with alternating closed inflow and outflow channels, for the most part made of ceramic, filtration by means of the passage of charged gases through foams made from ceramic or also from metal, or filtration by means of through-flow filters usually made from metal have been adequately described in the literature and are on the market.

For innovations in particulate filters, concentration is novel and of significant technological importance.

Patent and patent application publications, such as U.S. Pat. No. 4,276,071 “Ceramic filters for diesel exhaust particulates,” the European Patent No. EP 0318958 “Exhaust gas treating device,” or the International Patent Application No. WO 2005/033477 “Particulate filter for a combustion engine,” describe the first approaches for adjusting the components to actual requirements. For the production method, according to the state of the art, predominantly the methods of the long-known extrusion molding, film casting and drawing technology with the associated joining technology, foaming, slip casting, and embossing and stamping are used. The most universal use, however, for the manufacture and industrial production method can be the method of three-dimensional screen printing of molded bodies and the three-dimensional printing of molded bodies by means of nozzles described in the Patent No. EP 0627983 “Method for production of molded bodies with predetermined pore structure.” In contrast, etching, erosion, and laser methods have indeed proven practical for prototype modeling but not for mass production.

The task of the invention is to systematically overcome in an application-oriented way the specific weak points and problems of catalytic converters and filters and to be able to counteract new, simultaneously arising problems due to product-oriented construction changes that are, in particular, independent of material.

The invention represents a systematic solution to the problems. It can be realized in mass production and improves the efficiency of particulate filters and also catalytic converters. The focus in the present invention is directed toward the type-specific ability to realize the components of particulate filter and catalytic converter under the aspect of increasing operating reliability, optimizing efficiency, and the individual processability and use as a product.

With reference to use as a product, in the scope of the invention different target parameters play a role, wherein, according to the application, the realization of one or more target parameters can be desired. Such target parameters can be, for example, the thermal conductivity, the flow resistance, the effect on guiding flowing fluids, such as gases charged with particles, in particular, combustion exhaust gases, the mechanical stability, and/or the temperature stability of the product.

To solve the problems described above and to achieve the task of the invention, a system component of the invention is the definition of the problems for, in particular, already existing components. The second system component is the generation of individual construction elements for the specific problems. The third system component is the functional integration of the system components into the component. From these systems, the integrative solution of very different problems and combinations can be applied in modules to the specific requirements on the components usefully, quickly, and economically and can supply a realization and an application. The relatively tight limits of the construction set that can be realized with previous methods, that is, a plurality of construction elements present in a component, can be expanded to the extent that it is actually possible to realize application-optimized system solutions, which is claimed according to the invention.

The first part of the invention relates to the theoretical detection of existing and possible problems of products that have a cellular structure, wherein the elements forming the cellular structure are porous in one variant of the invention and comprise, for example, a ceramic, in particular, sintered silicon carbide. Such products can be, for example, catalytic converters and particulate filters for combustion assemblies and is claimed according to the invention as a first module for the system solution in connection with the other modules as an example for additional problem definitions and fields of application. These are essentially, but not exclusively, the following example problems (P):
P.1 For the field of application of particulate filtration, the following example problems are listed:
P.1.1 Direct additive propagation of force lines within the cellular structures that lead to high stress
P.1.2 Production of stress spikes at the contact points of channel walls due to small flank angles that tend to form cracks
P.1.3 Incorrect distribution of the inlet channel surface to the outlet channel surface that influences the flow resistance
P.1.4 Filling of the inlet channels with soot and ash from the channel end to the channel beginning that strongly influences the exhaust-gas counter pressure
P.1.5 Non-combustible combustion residues and additives remaining in the inlet channel that strongly limit the active, available filtration surface
P.1.6 Inhomogeneous heat distribution in the channel length direction for the regeneration of channels that leads to long regeneration times
P.1.7 Inhomogeneous inflow of combustion exhaust gases across the filter cross section that creates an inhomogeneous loading of the inlet channels with combustion products
P.1.8 High losses of product for the further processing into filter systems caused by the forces arising in the component package, which often leads to breakage of the components
P.1.9 Limited housing geometry and exhaust-gas guidance through the usually monolithic construction of the filter elements, which leads to conflicts with the available space in the frame-and-body construction
P.1.10 Miscellaneous problems caused by the materials of the filter elements and other problems
P.2 For the field of application of catalytic converters, the example problems are listed:
P.2.1 High material fraction for low surface area causes unfavorable flow ratio, which leads to low wall contacts
P.2.2 The conservative channel shape causes a low thermal stability that prevents placement close to the engine, which leads to low reaction temperatures that require, in turn, a large catalytic converter component
P.2.3 The coating methods used for the monolithic catalytic converter carrier can be constructed only with a type of catalytic converter that causes high material usage
P.2.4 The monoform channel shape offers only small variations in the treatment of reaction zones, which leads to large-format components
P.2.5 The direct communication between catalytic converter to a particular filter is realized in multiple-part exhaust-gas systems partially in the same housing, partially in several housings, which leads to complicated joining and sealing techniques
P.2.6 The monolithic structural shapes permit useful measurement technology only at the inflow and outflow positions, which leads to a low measurement-specific detection of reaction parameters.

Other problems can be extracted from the publications on catalytic converters and particulate filters or can be determined from real objects, partially brand new, partially at different stages of use.

The second part of the invention relates to the theoretical detection and generation of possible construction features for the components of the products named above, such as catalytic converters and particulate filters for combustion assemblies, which is claimed according to the invention as a second module for the system solution in connection with the additional modules. As an essential contribution to the inventive modular solution of the problems, these individual module components are also claimed by themselves according to the invention. These are essentially, but not exclusively, the following construction features (K).

The following construction features are presented especially for the category of particulate filter but can also be relevant for other categories of products.
K.1 While conventional cellular structures allow the propagation of force field lines caused by mechanical and/or thermal stress, tensile stress, compressive stress, bending stress, or their combinations, the construction feature according to the invention is the integration of stress-distributing and/or stress-deflecting elements in the working region of the product, for example, in the incident-flow area during operation, in particular, the filter surface. One embodiment is here, for more or less rectangular cell structures, the insertion of internally hollow elements into individual or multiple node points of the cellular structures, wherein the inner diameter of the stress-collecting and stress-deflecting elements is usually selected larger than that of the wall thickness of the cell structure.
K.2 Thermal and mechanical stress cause an increased risk of crack formation caused by stress spikes at the wall transition points and/or at connection points. According to the invention, the construction feature is the addition of stress spike preventing elements at the corners of the contact points in such a way that the connection angles of the channel walls, regardless of the angle they assume relative to each other, are expanded by more or less pronounced rounding elements. The dimensioning and bending of the stress spike preventing elements is directed according to the dimensions of the stress to be expected and the available space.
K.3 In particular, but not exclusively, a different volume and/or cross-sectional ratio of the cells in a component is required. Therefore, according to the invention, the construction element is claimed that allows individual adjustability of the ratios. An example embodiment comprises spacing elements between the individual channels of the component such that, using the example of round channels with a uniform arrangement in a group-of-four combination that form a fifth channel element, at opposing segments of a circle, a connection element of arbitrary length is employed. According to the length of this connection element, the ratio of the parameters of the fifth element changes. In the embodiment of the triangular offset arrangement of the flow channels in which three channels enclose a fourth channel, analogously a connection element is set between the channels. According to the length of this connection element, the ratio of the parameters of the fourth element changes. Analogously, the construction is to be understood to the extent that this construction element can be applied to all other geometric channel shapes.
K.4 The volume flow charged with particles should be fed to a filter. Here, the theoretical work to be performed is dependent on the available filter surface and the particulate number and size and forms the volume flow counter pressure, while in the outflow channels, only the discharge of the volume flow freed from particles is required. In this respect, the ratio of work output is shifted toward the inflow channel. To counteract this, in the construction feature according to the invention, the inlet channel is expanded to its maximum size and the outflow channel is reduced to its minimum size.
K.5 The charging of the inlet channels is dimensioned by two characteristic values. One is the temporary charging of the inlet channels with soot that forms a filter cake on the channel walls, optionally displaced with additives added for promoting regeneration. Here, the inlet channel fills up starting from the side of the lowest flow rates. This filling is temporary. The components that can be converters are removed during regeneration. The second is the permanent component in the filter cake composed of non-combustible impurities and/or additives. With advancing regeneration, these components are released and transported away through the flow path of the volume flow and through physical agitation at the end of the inlet channel. This material transfer leads to a constant filling of the inlet channel with so-called ash that prevents the filtration effect of the filter wall at its deposition position. According to the invention, the structural element for minimizing the effect of ash deposition starting from the end of the inlet channel is that the inlet channel constructed as a filtration chamber leads out from one or more outlet channels. Here, the direction of outlet channels within the filtration chamber can be selected arbitrarily. Here, the construction feature according to the invention of the effect of the force of gravity on the deposition characteristics of the ash components has the effect that the ash is concentrated predominantly in the lower and/or rear region of the filtration chamber and thus does not influence the predominant part of the filtration walls of the outside of the outlet channels.
K.6 While considerable advances have already been made in the life cycle phase of filter elements in passenger cars, this is not the case for other combustion assemblies, such as utility vehicles, with, to some extent, considerable deposition quantities. The continuous and/or discontinuous discharge of deposits from the inlet channels here represents the most significant problem. Through a construction element according to the invention, the present inventors solved the problem by installing a discharge device in the position of the filter element with the highest likelihood of ash accumulation. In the case of a cellular inlet channel form, this is a flap located in the region of the inlet channel ends and/or shifting device that opens the ends of the inlet channels and/or closes the outlet channel ends and presses out the collected ash from the filter element, advantageously at the end of a regeneration phase, in order to minimize the soot components in the discharge volume by means of a pressure surge. In the case of use of the filtration chamber, the construction element according to the invention is a flap arranged in the chamber wall, but advantageously not exclusively at the base of the filtration chamber. A technologically more demanding solution is the attachment of a discharge device in the form of a lock, e.g., in the embodiment of a rotary valve or that of a slide that also allows an assembly-friendly discharge of the ash components without a stay at a factory. For the concentration of the ash deposits at the discharge location, a free space in the form of a collection zone that can be kept arbitrarily large according to individual space relationships can be established there. It is essential that the largest possible percentage of soot, also in the ash collection region, can be exposed to the regenerative processes and not located in a low-reaction and/or reaction-free space.
K.7 The non-uniform temperature distribution within the filter channels does not pose insignificant problems in the treatment of solid components of the exhaust-gas volume flow, in particular, in the regeneration. First, the regeneration advances in the form of a heat wave from the inlet side of the inlet channels to the channel end, which also leads, in addition to an inhomogeneous heat distribution in the longitudinal direction of the channels, to considerable stress fields. Second, the regeneration effect becomes increasingly slower over the channel longitudinal axis with advancing regeneration, because the already regenerated front channel regions always have a significantly higher filtration power and thus a significantly higher volume flow throughput than the first partial or not yet regenerated channel regions. One construction element according to the invention is the integration of a porosity gradient in the longitudinal direction of the inlet channels. While a high porosity, in number and/or size of the pores, is selected in the inlet region and thus the filtration volume flow is high and thus also the formed filter cake can have a maximum construction, against the channel end a lower porosity is selected, so that there the volume flow of the filtration is at the lowest and only a smaller filter cake is made. This aspect causes a homogenization of the regeneration temperatures and a homogenization of the regeneration times. This problem can be completely eliminated by the construction element according to the invention for the construction of a filtration chamber in which, for example, the regeneration can take place nearly or even completely uniformly and at the same time in all filter chamber regions, because a homogeneous pressure and temperature situation is present at all regeneration points of the filter chamber. The effect of shortening the regeneration times is here given from the simultaneity factor of the regeneration across the filter volume.
K.8 The individual problem of inhomogeneous filling of the individual inlet channels of the filter elements caused, for the most part, by asymmetric volume flow feeding and volume flow distribution represents an essential problem for the regeneration of the filter elements, whose effect leads predominantly to a shortening of the regeneration intervals. During the regeneration, because an increased degree of engine control effects is required and here, in particular, unfavorable process parameters exist for the drive energy conversion, this acts, in particular, on the engine output and fuel consumption. The different inlet channels charged with particles actually require different regeneration times due to the differing amounts of purification currently oriented to the least favorable—that is, longest lasting—regeneration times of the individually charged channels. For the channel-shaped inlet channels, this is counteracted in the construction feature according to the invention by the integration of a gradient of the channel widths individually adapted to the engine requirements, so that, by means of the free flow cross sections, a homogenization of the exhaust gas volume flows is achieved with respect to the available filtration surface. In the case of the exhaust gas filtration across a filtration chamber, this effect has a significantly smaller result, so that here, lightweight aids can be created with the integration of flow guiding elements in the chamber cross section.
K.9 Of lower significance for the function of the filter elements themselves, but of higher significance for the economics and operating reliability of the system itself is the high risk of breakage in the handling of the filter elements for further processing. Due to the small wall thicknesses and the high degrees of porosity, the filter elements frequently break during the packing and sealing in the housing. This is counteracted by the construction feature of reinforced construction of the outer walls, which is claimed according to the invention. In the special form of the wall reinforcement, this is a construction with integrated stress dissipation and stress deflection elements. Very especially, this construction accounts for the condition that here, for different wall thicknesses, extreme temperature differences also occur, especially because this outer wall of the filter elements is exposed to increased temperature gradients and can expand only outward. All of the stress must be absorbed by the peripheral edge itself. In this construction element, special consideration is given to the condition that, according to the mechanical loading by the housing of the element during operation, the heat expansion stress acts from the interior of the filter element and simultaneously the counter pressure acts through the sealing materials from the housing onto this filter element zone. Also, the position of highest thermomechanical loading is generally combined.
K.10 The possibilities of housing shapes are relatively small due to the known monolithic filter element constructions. According to the invention, this problem is taken into account in that for the embodiment as a filtration chamber, an introduction of the exhaust gas volume flows is possible from all directions just like the discharged, purified exhaust gas volume flows can be discharged in all directions. In the simplest construction, the two volume flows can be in the same direction. In the extreme case, a variant with completely opposite flows can be realized. The possibility of multiple dissipation of the exhaust gas volume flows can be emphasized in particular, because the filter chamber version permits dissipation in several directions simultaneously. One possible construction is here the combination of discharge channels into one collective channel that represents, in turn, individually or together as a group the final discharge channel. Therefore, the exhaust gas paths after the filtration can be minimized and, for example, a counter-flow behavior within the filter can be illustrated for simultaneous discharge of the exhaust gases in any direction.

Additional construction features follow that are especially suitable for the category of catalytic converters.
K.10 The surface available for the flow profile is of primary significance especially for catalytic conversion of exhaust gas components. The conventional square channel shapes here carry a flow in one direction and thus also define the residence time of the exhaust gas volume flow in the catalytic converter elements. Because the mounting possibilities within and underneath vehicles are limited, the catalytic converters must be built with a large peripheral extent, in order to guarantee sufficient wall contacts of the exhaust gas volume flow for predominantly non-turbulent flow with the catalytic converter walls. The construction element according to the invention for this problem is represented by the integration of turbulence-generating structural elements, e.g., by swirl segments, arranged parallel to the catalytic converter cross section within the flow channels. Another possibility is the integration of flow screens of small thickness that also lead to increased wall contact of the exhaust gas volume flow. In the simplest embodiment, grooves or bars running in the same direction are provided to the channels. These grooves or bars considerably increase the active available surface, even if the channel cross section is increased, without increasing the effective flow resistance.
K.11 The monolithic structure of the flow channels usually in a polygonal construction is exposed to the same thermal stress as the particulate filters. However, here an internal breakage of a channel is not a failure criterion, because no separation takes place in the exhaust gas volume flow. However, if such breakages occur at several locations, then this inevitably leads to failure of the catalytic converter body. The construction feature of increasing the thermomechanical stability is to be taken analogous to that of the particulate filter. If these components are integrated into the catalytic converter carrier, a placement closer to the engine is possible, which means higher inflow temperatures of the exhaust gas volume flows and thus allows a reduction of the catalytic converter concentration.

These two construction features are representatives for a series of additional construction features included for those skilled in the art in the invention described here.

Below, as an example, a few problems of the solar receiver and its construction elements will be described as representative and without limiting generality and are claimed according to the invention:
P.3 Problems of the solar receiver in energy generation
P.3.1 In solar energy generation there are problems in the solar receivers for energy converters named as solar-heat power plants. One problem is the flow resistance of the receiver that strongly influences the flow rate of the heat-exchanger air
P.3.2 Another problem is the non-uniform heating of the receiver considered as an individual component
P.3.3 Another problem is the monolithic, uniform construction of the flow channels that allow only a limited energy transfer between the receiver and carrier air
P.3.4 Another problem is the reaction inertia of the receiver for rapidly changing radiation energy concentrations
P.3.5 A not-insignificant importance in energy generation is the problem of loss at the reaction surface for the energy transfer through mounting surfaces
P.3.6 One last problem that is not to be considered final is the weight load caused by the receiver on the sub-structure

The construction elements that can be defined for these problems are presented below according to the invention, wherein the list has merely examples. Those skilled in the art will identify additional construction elements that emerge, in principle, from the examples.
K.12 The functional problem of the pressure required for generating the flow can be counteracted, in principle, by the construction element of shortened length of the solar receiver channels. For increase of the wall contacts through suitable elements that lead to increase heat transfer between the receiver wall surface and carrier air, a functional shortening of the receiver length to values less than 100 millimeters is possible. Under the aspect of economics in system construction, here advantageously receiver component heights less than 100 millimeters, advantageously less than 80 millimeters, are to be preferred ideally.
K.13 The basic problem of the non-uniform heating of the solar receiver across its cross section can be counteracted by the construction element according to the invention to the extent that a higher flow of carrier air is allocated to regions of increased temperature determined experimentally and/or by calculation than those of lower temperatures. This is achieved in the construction element by an increase of the receiver channel cross sections and/or by the integration of flow channel cross sections of lower flow resistance. The increase in flow rate of the carrier medium caused in this way causes strong cooling and thus leads to temperature equalization. This construction element can be realized in an especially advantageous way at corners of the receiver surface. Here, this construction element can be constructed across the entire receiver channel length or only on the radiation energy side and/or on the discharge side of the carrier flow.
K.14 Due to the low flow rates, the problem of monolithic receiver channels according to the state of the art for the most part causes only a non-turbulent carrier air flow that has, due to the uniform volume flow, a low heat transfer effect from receiver channel surface to carrier air. This problem is taken into consideration by a construction element according to the invention in that, in the flow path, breakaway edges are formed that cause a moderate swirling of the volume flow, without triggering thermal blockades. One example embodiment is here a reinforcement of the channel walls after the heat entry zone. The air flow striking the reinforcement impacts the widened section and becomes turbulent. The same effect is given when the construction element is constructed such that several absorber channels of the inlet side open into a continuation channel. At the transition point, channels walls of the inlet side end and also form breakaway edges and/or transitions that lead to swirling and thus better heat transfer.
K.15 The problem of receiver inertia with respect to absorption energy causes a massive effect on the temperature gradient that can be achieved in the carrier air. The greater the temperature difference of the introduced air is to the heat air after passing through the receiver, the smaller the air volume flow can be selected for equal energy transfer output and/or for the same volume flow the usable energy transformation can be increased accordingly. Because the introduced energy beams penetrate only a few millimeters directly into the receiver surface, the construction element is that of the maximum absorption surface for smallest flow resistance. Advantageously, but not exclusively, this being achieved by the construction of more or less round inlet openings to which additional absorber surfaces, e.g., in the form of bulging sections, depressed sections, bar segments, or add-on segments, are optionally allocated by the surface shape of the flow channels. This absorber surface that can be configured optimally in terms of flow and heat transfer can transition into a channel cross section that is optimum in terms of flow after a few millimeters for reducing the flow resistance. Here, it is an advantage according to the invention when the receiver surface for the energy absorption in the receiver with rapidly reacting material compositions, e.g., through low density, fine graininess, and/or pore volume and size, directly or indirectly border a lower lying receiver part that has a higher heat storage capacity and is used as an equalizing receiver element and here simultaneously has stability-increasing properties.
K.16 The construction feature according to the invention for the problem of reactor surface not available for the energy generation is achieved in that the individual receiver of the reaction surface by the integration of stress-dissipating or stress-deflecting partial segments, so that according to the state of the art, with polygonal receiver cells, larger area receiver elements can be achieved, i.e., with at least 100 cm² reaction surface, but advantageously with reaction surfaces of the individual solar receiver greater than 196 cm² Therefore, the reduction of the reaction surface is strongly reduced by the carrier construction, so that the obtained surface can be used for energy generation.
K.17 The construction element according to the invention for the problem of weight loading of the reactor surface sub-construction is solved in that the materials used for the solar receiver are provided with a porosity that only insignificantly influences the effective heat conductivity within the receiver material. For this purpose, the receiver material is prepared either from porous metals or from porous ceramics such that the crystal components have internal contact points—and thus achieve the necessary strength and heat conductivity, without the raw density of the receiver material being high.
K.18 For a technological optimization of the solar receiver, the construction element of multiple individual elements has proven possible. With this element, different types of flow structures and/or materials and/or material properties, such as density, heat conductivity, porosity, and/or different production techniques are packed one on top of the other, which leads to a package and is either joined together rigidly into one component or is merely held together by the housing border or is even just pressed together by its own weight, wherein the pressure of the carrier air flow produced during operation supplies its contribution to coherence. In this way it is possible to respond in a targeted way to the very different thermomechanical states of the solar receiver and the requirements on the individual planes of the receiver, without having to take into account material and/or shape restrictions. Thus, as an example and not exclusively, a thermal booster made from high temperature-resistant ceramic material with minimal change in dimensions due to heat, but with extremely high absorber power can be used in the inlet zone of the solar receiver, followed by a metallic heat transfer element with a channel shape that is closed by a foam matrix.

Also for the sake of simplicity, as representatives for additional applications, a few problems of joining technology and their construction elements shall be described as examples and claimed according to the invention:
P.4 Problems of joining technology in mutual component sealing
P.4.1 The joining of thermally and/or mechanically high load-bearing parts as a rule requires a large sealing surface. In particular, this is the case for thermally loaded housing parts. The essential problem is here the thermal expansion of the parts that also appear in the sealing region.
P.4.2 One basic problem is the material of the seals. Due to technological processing, seals are used that indeed have high expansion elasticity, but are mechanically unstable relative to the part stability. The effective stability composite is here usually generated by the connection elements.
P.4.3 For the use of closely packed components, as a rule the integration of so-called labyrinth seals is preferred. The adaptation of sealing surfaces of the labyrinth seal to the parts to be seals here represents a basic problem.

Additional problems can be supplemented with reference to the technological problems in joining technology by those skilled in the art with reference to this procedure.

The construction elements that can be defined for these problems are presented below according to the invention, wherein the listing is only an example. Those skilled in the art will recognize further construction elements in the principles that emerge from the examples.
K.19 In joining technology, the material used for sealing the parts should behave as much as possible like the parts to be sealed. This is seldom the case especially due to the limited manufacturability, in particular, for metallic seals. The component solution for this problem is solved according to the invention in that the seal itself is made from the same material from which the parts to be sealed are made. Here, for the parts materials, the same material category is also used: for metal, metal is used, for ceramic, ceramic is used, and for plastic, plastic is used or also combinations of these materials.
K.20 The problem of the low mechanical stability of the sealing materials and/or shapes as a rule represents a weak point for the entire part. The component solution according to the invention is based in that the sealing element itself has a stability that is at least equal to that of the part itself through the integration of sealing chambers that can be compressed during assembly and/or that expand or contract under a load.
K.21 The problem of the sealing adaptation to the sealing surfaces of the parts is usually generated by labyrinth seals and/or by wide sealing surfaces. Here, especially for changing thermal and/or mechanical loads, especially at corners or tight curves, leakage appears in the seal. The component solution is here the seamless hollow chamber seal in which the hollow chamber can vary according to the requirements of the sealing position to the extent that the hollow chamber is more or less thick, branches into several chambers, has different wall thicknesses, and especially but not exclusively has no seam positions.

While the problems (P) are presented, for the most part, typically for the application, the construction elements (K) represent solutions of general applicability that can be constructed specific to the application in the scope of the invention. Thus it is possible that construction elements that have been generated for an application can definitely also be applied to other applications and there also contain a portion of the problem solution. In this respect, the listing of the construction elements is to be understood to the extent that these are used not only for the special application under which they are presented, but can relate to any application of this invention.

The third part of the invention is the combination of the different individual solutions of the component solutions to the problems into a solution system with at least one or more individual solutions generated from the preceding modules listed according to the invention. This is listed essentially but not exclusively using one example and can be easily expanded by other examples by those skilled in the art with reference to the description (V):

V. The effectiveness of the system for the modular solution of problems in the optimization of cellular components is here presented as an example with reference to the particulate filter for combustion assemblies, with reference to the segment of passenger cars and the filtration of diesel particulate filters for further applications of the solution system:

Module 1 is here assembled for diesel particulate filters for passenger cars in the solution matrix from the problems, following the nomenclature of this description. Module 2 is here assembled from the sum of the component solution for each individual problem, following the nomenclature of this description in the solution matrix.

In the system consideration, now a rising value is assigned to each problem in the form of points (1)P.x.y from 1 to 100 that is derived from the requirement profile for the application of the rank. In the system consideration, a value is assigned to each component solution for the associated problem in the form of points (2)K.x.y from −100 to 100, that is, also the damages.

From the values of the problems and the component solution, the product is formed (1)P.x.y*(2)K.x.y that is designated E.x.y. Now, from the individual products of the problem and component solution, the sum is formed that is designated S.x.

If a sum of the individual products of the problem and component solution achieves a negative value, then this component is to be interpreted as damaging for the product, unless an exception requires the acceptance or toleration of a component that is damaging for the system. The other positively valued components are now classified as acceptable for the product according to their point status and allocated to the different production methods H.1,2, . . . x, wherein an optimum production method is assigned to each component solution.

From the sum of product points of each allocated production method without consideration of the component solutions with negative valuation point status, the result of the greatest possible optimization for the product is given for the use of component solutions that can be applied under a production method.

Here, the valuation matrix for the system of the modular problem solution by means of component solution through the allocation of different production methods to each component solution can also be provided with a value, in order that the matrix can be arbitrarily expanded, which is easy for those skilled in the art to perform.

This objective, decustomized optimization as a result of the system application must now be adapted to the actual conditions. These include primarily the availability of production capacities, the economic profitability of the optimization, the customer requirements, and other conditions that do not coincide directly with the product itself and its optimum construction.

In a matrix listed as an example with fictitious parameters as shown below, the component solutions K.2 and K.3 achieve the best possible optimization of the product under use of the production method H.3. Specific to production, if there is the possibility of integrating the production method H.1 into the production sequence of the production method H.3, the component solution K.5 is also conceivable as the subsequent optimization stage. The interpretation of the results of this example clearly shows that the production method H.2 is less suitable for optimizing the product and that the component solution K.1 overall can even exert a negative influence on optimization. Here, the negatively influencing component K.2 is taken into account in the problem P.1.2, because the positive effect of this component K.2 on the problem P.1.1 acting with a higher value of problem classification is interpreted as more important. In contrast, the positive effect on the optimization of the component solution K.1 on the problem P.1.2 stops the higher classified problem P.1.1 on which the component solution K.1 has a negative effect on the degree of optimization.

System matrix for optimization of problems by means of component solutions

| | | Module 2 | | | | | |
|---|---|---|---|---|---|---|---|
| Module 1 | | Component Solutions | | | | | |
| Problem | Point 1 | K.1. | K.2. | K.3. | K.4. | K.5. | K.x. |
| P.1.1. | (1)P.1.1 | (2)K.1.1 | (2)K.2.1 | (2)K.3.1 | (2)K.4.1 | (2)K.5.1 | (2)K.x.1 |
| Product (1)P.1.1*(2)K.x.l | | E.1.1 | E.1.2 | E.1.3 | E.1.4 | E.1.5 | E.1.y |
| P.1.2. | (1)P.1.2 | (2)K.1.2 | (2)K.2.2 | (2)K.3.2 | (2)K.4.2 | (2)K.5.2 | (2)K.x.2 |
| Product (1)P.1.2*(2)K.x.2 | | E.2.1 | E.2.2 | E.2.3 | E.2.4 | E.2.5 | E.2.y |
| P.1.x. | (1)P.x.y | (2)K.1.y | (2)K.2.y | (2)K.3.y | (2)K.4.y | (2)K.5.y | (2)K.x.y |
| Product (1)P.1.y*(2)K.1,2, . . . y | | E.1.y | E.2.y | E.3.y | E.4.y | E.5.y | E.x.y |
| Sum of Products | | S.1 | S.2 | S.3 | S.4 | S.5 | S.x |
| Production | | H.1 | H.2 | H.3 | H.4 | H.5 | H.x |

| | | | |
|---|---|---|---|
| | | Sum | Sum |
| | | H.1.x | H.2.x |
| Sum of Production | H.1 | Sum H.1.1 | SumH.2.1 |
| | H.2 | Sum H.1.2 | Sum H.2.2 |
| | H.3 | Sum H.1.3 | Sum H.2.3 |
| | H.x | Sum H.1.x | Sum H.2.x |
| Negative | | Without | With |
| Components | | | |

Finally, the preceding modular solution of problems according to the invention is claimed by individual or combined application of the modules according to the invention as a basis for use in gasoline assemblies, diesel assemblies, gas-operated assemblies, in solid-operated assemblies, in assemblies operated from combinations of these, and also for application in hybrid assemblies with electrical components.

In particular, but not exclusively, the object of the invention is the use of the preceding system solution for use as a catalytic converter, as a particulate filter, or as a combination of these for exhaust gas systems of combustion assemblies.

In particular, the object of the invention is the use of the system solution for use in passenger cars, utility vehicles, stationary work machines, mobile work machines, propulsion systems, jets, household heating systems, power plants, and other systems in which exhaust gas flows are present or generated.

Included here is the use of the system solution according to the invention also in other systems, such as heat exchangers, mass separation systems, dispersion devices for reducing and/or distributing fluid elements distributed in another fluid, static mixers, energy generation systems, or sealing systems that represent only examples for a series of additional applications under the presence of volume flows that can be easily imagined by those skilled in the art and represent only examples for the universal applicability of the system and are also claimed.

The invention thus provides a device through which fluid can flow, such as, for example, combustion exhaust gas charged with particles and that comprises a work region with a cellular structure, wherein the cellular structure has a shape and/or dimensions in the longitudinal and/or transverse direction of the device—wherein the longitudinal direction is the direction in which the fluid enters into the device during operation of this device—such that with reference to a monolithic device with at least two channels that are rectangular in cross section, the heat conductivity is larger and/or the flow resistance is lower and/or the mechanical resistance, in particular the compressive and/or the tensile resistance, is higher and/or the temperature stability is higher.

The device according to the invention comprises, in an advantageous improvement, reinforcement elements in the cellular structure. For example, the device has a region that has additional braces in addition to the walls that are required at least for forming the cellular structure.

In another embodiment of the invention, the device comprises at least two regions with different size cells in the corresponding cellular structure.

The elements of the device forming the cellular structure, in particular, the walls, are porous in one variant of the invention and comprise, for example, a ceramic, in particular, sintered silicon carbide, and/or at least one metal and/or at least one glass.

In one preferred embodiment of the invention, the device has at least one inlet and at least one outlet channel. Advantageously, in this device according to the invention, the ratio of cross-sectional surface of the inlet channel to cross-sectional surface of the outlet channel is greater than 1 and preferably lies in the range of approximately 1.4 to approximately 1.8, especially preferred at approximately 1.6.

The invention also provides a method in which a device through which a fluid can flow is created with a cellular structure, wherein the elements building the cellular structure, in particular, the walls of the device are porous, wherein a plastically deformable mass that can then be compacted is provided and the following two steps are repeated alternately, in order to build a certain cellular structure layer by layer:
generating a layer structured corresponding to the cellular structure from the mass,
compacting the layer,
wherein the structured layer is constructed with respect to the application. For the construction of the layer or the cellular structure, the process is performed as described above with reference to the modular system for optimization.

For illustrating the system of the system solution according to the invention by means of modular components, below a few examples, and thus not exclusive embodiments for the realization of the invention will be listed. As representatives for the possible fields of application according to the invention, examples for particulate filters, catalytic converters, solar receivers, and seals are listed. Further examples for the application of the invention are easy to determine for those skilled in the art according to the system according to the invention and are to be solved systematically.

### EXAMPLE 1

### Passenger Car Soot Filter

If the modular system is now applied to use in diesel soot filtration for passenger cars, then the significant problems are defined in the problems of categories P.1.1 to P.1.8 according to the first module of this description. The component solutions taken into consideration can be represented on the range of component solutions K.1 to K.9 as module 2. The most essential problems are: The filling of the inlet channels with ash components that currently allow a lifetime of the filter elements of approximately 120,000 km before the available filter surface becomes too small and the exhaust gas counter pressure increases non-proportionally and the exhaust gas volume flow becomes too low. For engine runtimes today of more than 200,000 km, a filter change is currently still the only solution.

The second essential problem is the progression of thermomechanical stress across the filter cross section. The stress addition lead to material breakages that eliminate not only the filtration effect at these positions, but instead of this, mechanical wear at the breakage edges also leads to filter destruction, especially for large temperature changes in the inlet channels. The third essential problem is the total mechanical sensitivity during the production of the filter systems essentially caused by the small wall thicknesses and the high degrees of porosity that are required for the lowest possible exhaust gas counter pressure through the material.

In the regeneration of the filter elements, in particular, the non-uniform channel filling, e.g., across the channel cross section, a polygonal channel has a thick-film soot charge in the corners that assume a round flow channel inner shape until filled up and the beginning of regeneration. The thickness increased by, e.g., 1.4 times in the corners also requires a regeneration time increased by 1.4 times, that is, the flat side walls of the inflow channel are already regenerated while the regeneration is still taking place in the corners and thus is first available for the diesel soot filtration in a delayed way or already has, after a short charge time, a strongly pronounced filter cake that reduces the filtration power with respect to the volume flow. Here it is to be taken into consideration that the filter cake generates, for example, an exhaust gas counter pressure increased up to 6 times as the substrate of the channel wall of the filter element before the regeneration takes place.

The analysis of the problems and the component solutions leads to a combination that is merely an example for further possible optimization according to this description such that the filter element contains the following components for the problem solution:
the inlet channels have a round shape and enclose the outlet channel such that a maximum thermomechanical stability of the channel is achieved, a maximum possible homogeneous soot charge state is possible, lowest possible flow resistance is generated in the channel longitudinal direction, and other lower-order optimization factors
The inlet channels are each separated from each other by spacing bars on directly opposite walls such that thermomechanical stress progression is deflected in a targeted way, the size ratio of inlet channel to outlet channel can be set arbitrarily, on the one hand, by the dimensioning of the spacing bar, on the other hand by the free dimensionability of the inlet channels. In this way, as an example, a volume ratio greater than 1.6 to 1 of inlet channel volume to outlet channel volume can be generated, which means a factual increase in capacity from currently 120,000 km to more than 190,000 km.
The transition points from spacing bars to the channels are provided with rounded elements that cause a soft deflection of the stress at the corresponding adjacent filter channel. The associated significant thermomechanical stability increase can be used to the extent that the filter channel walls can have a thinner construction, and a higher porosity can be integrated, which leads to lower substrate-related flow resistance or else is used merely for reducing the risk of breakage.
The outer wall of the filter elements is provided with an increased thickness that contains additional stress-distributing elements in addition to the higher material portion. In this way, the mechanical stability of the entire filter element is significantly improved for the housing, but also the operating stability is increased, because the reinforced outer wall can also absorb more stress from the filter interior.
Additional improvements, such as a one-chamber system, a disposal device for ash, a flow direction change, or other channel shapes, such as triangles, hexagonal shapes, channel diameter gradients across the filter cross section, porosity gradients across the filter element length, and more are possible and evident from this system for those skilled in the art.

The system of modular problem handing by means of components can be applied in the scope of a production method of the three-dimensional screen printing according to EP 0627983 or else also for printing the filter element by means of the method of jet printing also described in this patent publication.

Especially suitable for producing a device through which a fluid can flow as described above with a cellular structure or a construction element described above is the following method provided by the invention. The invention also relates to a method for producing a device through which a fluid can flow with a cellular structure or a construction element, in particular, as described above, wherein the elements building the cellular structure, in particular, the walls of the device, are porous, wherein a plastically deformable mass that can then be compacted is provided and the following two steps are repeated alternately, in order to build a certain cellular structure layer by layer:
generating a layer structured according to the cellular structure from the mass,
compacting the layer,
wherein the structured layer is constructed with respect to the application.

In one preferred improvement of the method according to the invention, for the construction of the layer or the cellular structure, the process is performed according to the modular system for optimization as described above.

The invention will be explained in more detail below with reference to the accompanying figures with reference to additional embodiments. Shown are:

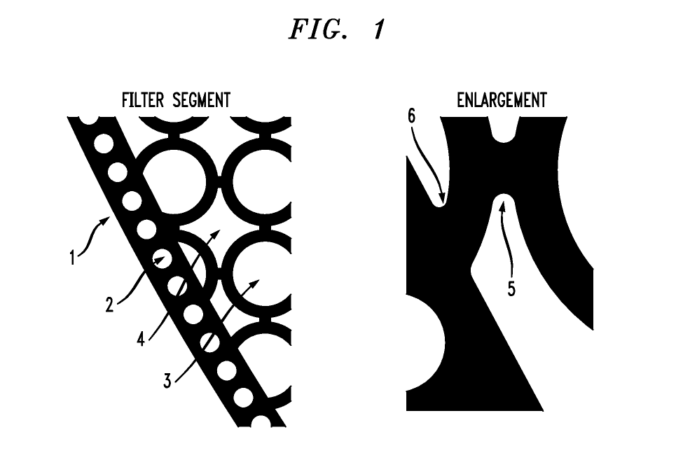

FIG. 1, a schematic diagram of a cellular structure for a diesel particulate filter in cross section (left) and in an enlarged detail view (right),

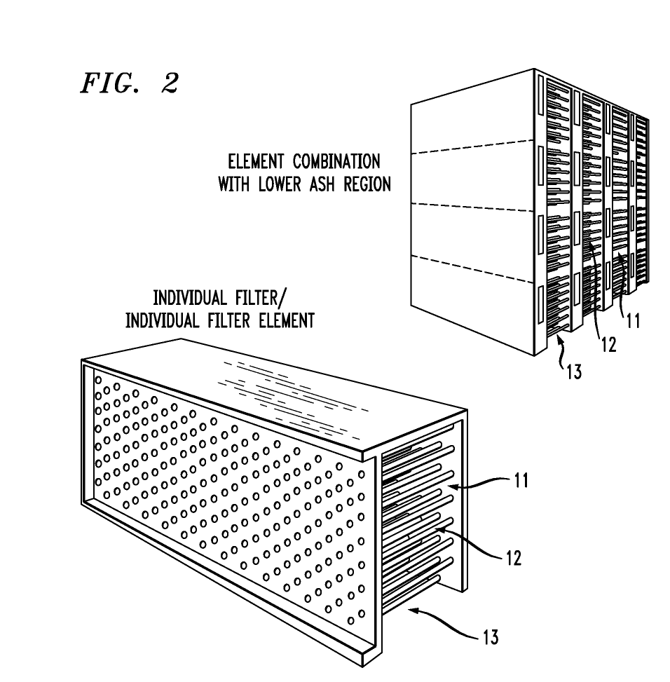

FIG. 2, schematic diagrams of element combinations for a diesel particulate filter in another embodiment of the invention,

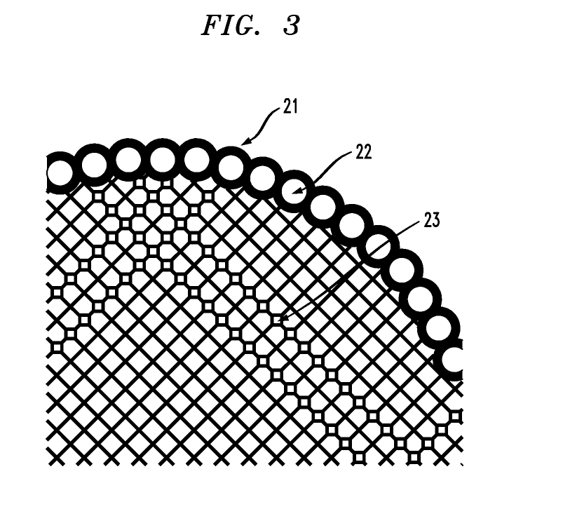

FIG. 3, a schematic diagram of a cellular structure for a catalytic converter in cross section, and

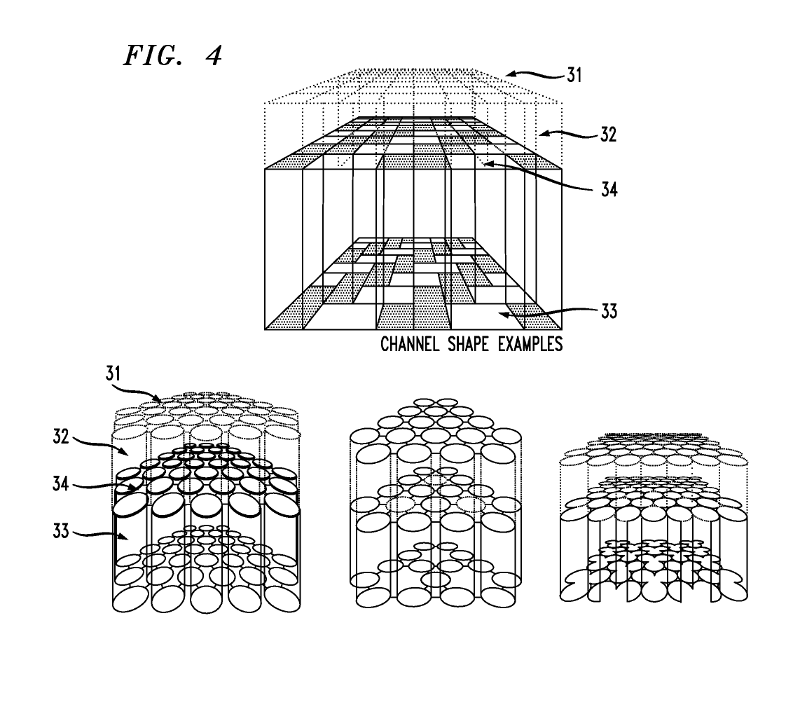

FIG. 4, schematic diagrams of cellular structures for a solar heat receiver.

As an example, and thus not exclusively, but merely as a representative for other solution products that can be derived from the description is an embodiment shown in FIG. 1 for a diesel particulate filter for passenger cars. Here, 1 designates the reinforced outer wall, 2 a stress collecting element in the outer wall, 3 an inlet channel, 4 an outlet channel, 5 a channel transition bar, and 6 a rounding element.

The shape of the transition between the inlet and outlet channels and also the shape of the stress collecting elements can be selected freely in the scope of the invention just like the outer dimensions of the component. In particular, as shown in FIG. 1, a round shape, for example, with circular arc-shaped transitions or circular stress collecting elements can be selected. According to the application, a shape of the individual elements that comprise a filter segment as shown in FIG. 1 can also be non-uniform and/or can comprise other shapes in addition to circular shapes, such as, for example, elliptical, beveled, polygonal, etc.

In addition or as an alternative to the shape, in another embodiment of the invention, the ratio of cross section of the inlet channel 4 to cross section of the outlet channel 5 is greater than 1 and preferably lies in the range from approximately 1.4 to approximately 1.8, especially preferred at approximately 1.6.

### EXAMPLE 2

### Truck Soot Filter

For the consideration of particulate filters of trucks, similar problems are essentially presented like for passenger cars from Example 1. Here, however, the weighting is targeted completely differently, so that the essential problems relate to the running power of the drive assemblies that can lie in the seven-digit kilometer range. In addition, the accumulation of soot is significantly larger and faster especially when carrying loads. If the system of modular problem solution by means of component modules is applied to this application, then this leads to the result that for this type of drive assemblies, in construction, the inlet chamber with integrated filter channels is the most useful and technologically most effective filter element shape. The smoothing chamber described in Patent Application No. WO 2005/033477 here does not represent a solution of the discharge problem for the ash, because not only ash, but also essentially soot collects in this chamber that can be barely reached by the regenerative conditions. In one embodiment, such a diesel particulate filter according to the invention that can be made from one part, but can also be made from several assembled parts, is shown in FIG. II. It is understood that in the structural shape, the integration of gradients in the parts arrangement and position, the grading of porosity, and, but not exclusively, the flow directions and other features can be easily imagined by those skilled in the art and can be integrated into the solution system.

Here, in FIG. 2, the inlet chamber is designated with 11, a filtration channel with 12, and the ash collection region with 13 in which, not shown, the discharge device can be implemented. In this construction, it is obvious that construction elements of this description, like those that also exist for the particulate filter for passenger cars and/or those of the catalytic converter, can also be integrated here. In this example, it is to be stressed, in particular, that the installation direction can be selected independently, which also allows an inflow of the exhaust gas volume flow from above, which in turn benefits the ash collection that is significantly simplified by the force of gravity. Shown is a filter with counter flow. It has been shown that also with this product, the production method according to Patent No. EP 0627983 is the most suitable.

### EXAMPLE 3

### Catalytic Converter

In the case of catalytic converters, today's problems are less dramatic, and there is an urgent need for improvement of the catalytic converters essentially from a marketing point of view, in particular, as a defining feature in cut-throat competition, in particular, in niche markets. In this respect, as an example and thus not exclusive configuration of the system of modular problem solution through component elements, here an example reduced to details is shown in FIG. 3. Here, 21 designates a reinforced outer wall, 22 the integration of stress collection and deflection elements in the outer wall, and 23 designates the integration of deflection elements for thermomechanical stress in the channel structure. Other component elements can be easily integrated in this system by those skilled in the art and are likewise claimed.

### EXAMPLE 4

### Solar Receiver

In solar heat energy generation, the focused light energy is led onto the surface of the absorber and absorbed by this surface. Here, in the radiation direction, air is drawn through the absorber that heats up due to the absorbed heat energy of the light radiation and is used either directly or through heat transfer processes, e.g., steam generation, for the conventional generation of electrical energy. In the examples of FIG. 4, a few, and thus not exclusive, possibilities of the solar receiver shape are sketched as they can be generated and produced from the present description. It is easy for those skilled in the art to imagine that here construction elements of the particulate filters, the catalytic converters, and other applications claimed according to the invention can also be applied to the solar receiver. Here, 31 designates the incident surface of the solar receiver, 32 the energy transfer channels, 33 the flow channels, and 34 the flow breakaway edge.

### EXAMPLE 5

### Seal

The problem of seals represents a wide range of special requirements. As a representative for the range, as the simplest example, the problem of joining peripheral seals made from hollow profiles is described. Here, as an example according to the system for modular problem solution from component modules is a construction of two housing components made from molybdenum by a peripheral, annular seal with a bar spring leading into the upper housing chamber and a bar spring leading into the lower housing chamber, whose connection is a wide hollow profile that is compressed in the housing assembly. Here, the two bar springs also flatten into the provided grooves in the housing, so that a multiple seal of the housing parts is produced, first by the resulting labyrinth of the bar springs and, second, by the compression of the hollow chamber. A special feature of this example is that the seal in the method according to Patent No. EP 0627983 can be produced without a seam from the same material has the housing parts. Here, the hollow chamber seal pressed, e.g., with molybdenum powder is treated and thus can assume the same material properties as the housing itself. The example is an example for other shapes and configurations of seals and seal systems that are imaginable according to this publication and that are also claimed. At this position it is also conceivable that not only the seal itself, but also the component is pressed, so that at least one housing half is produced together with the seal and thus a seal plane is completely eliminated.

### EXAMPLE 6

### Seal

A very simple sealing system solved according to the system for modular optimization of cellular structures is that of the cellular flat seal. In this embodiment, a flat, seamless, peripheral seal is made from one or more cells that each represents a sealing cell. Thus, in this embodiment, a series of parallel, peripheral chambers can optimally seal unevenness in the components to be joined. If the peripheral cells are divided into sub-sections, a system of sealing cells is produced that forms a seal that can carry a high load. Operating-related leakage of one and/or more cells does not influence the function of the other sealing cells. This results in a significant increase in the operating reliability of the seal.

Other examples can be easily derived and presented by those skilled in the art from the description and are also claimed according to the invention.

Based on the preceding constructions, the system presented according to the invention for modular solution of problems is claimed to the extent that this is used in the fields of volume flow treatment of fluid and/or gaseous media, in particular, but not exclusively, in the field of application of exhaust gas volume flow purification in the embodiment of catalytic converters and particulate filters or else in a combination of these parts for use in motor vehicles, work machines, power plants, energy generation systems, and other assemblies, such as household heating systems, block-type heating power plants, and others with components of exhaust gases and/or particles regardless of the composition from the reactions of the energy carriers that are used.

In addition, the system for modular problem solution is also claimed according to the invention in the field of renewable energy generation, as an example, and thus not exclusively, for solar receivers, heat exchangers, and wind power, but also for its use in fluid media, such as gravity-operated energy generation systems, geothermal energy generation systems, or tidal energy generation systems.

In addition, the system for modular problem solution is claimed according to the invention in the field of joining technology, as an example, and thus not exclusively for housing component seals, decoupling components, and equalization components in system components and for their connection.

All of the construction elements have in common that these can be constructed at best with the production method according to Patent No. EP 0627983. In particular, here three-dimensional screen printing allows an extensive coverage of the production possibility for existing products with far-reaching overlap of the component solutions within a component. According to the invention it is therefore claimed that the use of the system solution with reference to modules according to this publication is advantageously but not exclusively realized by means of the method according to EP 0627983. The realization of the system of the modular solution for cellular products, realization with the production method of extrusion molding, film casting, film drawing, slip casting, foaming, jet printing, and other suitable production methods that permit mass-production realization is also possible according to the invention.

With reference to the preceding constructions and examples, the following claims are claimed according to the invention. In particular, but not exclusively, all of the types of products are claimed according to the invention that can be derived from at least one of the claims for the device or for the construction element or for the system.

It is evident to those skilled in the art that the invention is not limited to the embodiments described above, but instead can be varied in many ways. In particular, the features of the individual embodiments can also be combined with each other.

1. A construction element through which a fluid can flow and that comprises a working region with a cellular structure, wherein the cellular structure has a shape and/or dimensions such that, with respect to a monolithic construction element with at least two channels that have a rectangular cross section, the thermal conductivity is greater and/or the flow resistance is lower and/or the mechanical resistance, is higher and/or the temperature stability is higher.

2. The construction element according to claim 1 with at least one reinforcement element in the cellular structure.

3. The construction element according to claim 1 with a region that has, in addition to the walls that form the cellular structure, additional braces that are required at least for forming the cellular structure.

4. The construction element according to claim 1 with at least two regions with different size cells in the corresponding cellular structure.

5. The construction element according to claim 1, wherein the elements forming the cellular structure are porous and comprise a ceramic and/or at least one metal and/or at least one glass.

6. The construction element according to claim 1 with at least one inlet and at least one outlet channel, wherein the ratio of cross-sectional surface of the inlet channel to cross-sectional surface of the outlet channel is greater than 1.

7. A system for modular optimization of cellular structures of a construction element according to claim 1, characterized in that the system is made from the modules of a problem definition, the module of individual component solution to the individual problems of the problem definition, the module of linking the individual component solution of the problems to each other, and the module of a matrix for selecting the solutions of the optimization and the selection of one of suitable production methods.

8. The system for modular optimization of cellular structures according to claim 7 characterized in that at least one individual component solution and one production method is allocated to a problem.

9. The system for modular optimization of cellular structures according to claim 7 characterized in that the system is applied to different fields of application that are to be allocated essentially, but not exclusively, to the areas of volume flow purification, energy generation, and joining technology.

10. The system for modular optimization of cellular structures according to claim 7 characterized in that a product problem is allocated to at least one product.

11. The system for modular optimization of cellular structures according to claim 7 characterized in that an individual component solution is allocated to several problems and/or products.

12-16. (canceled)

17. A construction element set comprising at least two construction elements, each of which according to claim 1, characterized in that the individual construction elements in the construction element set can be allocated to one or more application fields and/or problems.

18. The construction element set according to claim 17 characterized in that the construction element set is suitable to distribute and/or to deflect thermal and/or mechanical stress in the form of material-loaded bars and/or surfaces.

19. The construction element set according to claim 17 characterized in that the construction element set is suitable to produce a soft transition of stress spikes in the form of concave and/or convex rounded sections and/or curved sections.

20. The construction element set according to claim 17 characterized in that the construction element set is suitable to set the size relationships of adjacent channels individually and/or independent from each other, specifically, but not exclusively, this being a spacing element integrated between two adjacent channels.

21. The construction element set according to claim 17 characterized in that the construction element set is suitable to reduce or enlarge each individual channel to the dimension required for the channel, specifically, but not exclusively, this being the maximum size for inlet channels and minimum size for outlet channels or vice versa.

22. The construction element set according to claim 17 characterized in that the construction element set is suitable to form an inlet chamber from which leads at least one outlet channel that can be selected arbitrarily in its direction of volume flow, specifically, but not exclusively, this being an inlet chamber with one or more outlet channels that are separated from the inlet chamber by a filtration wall.

23. The construction element set according to claim 17 characterized in that the construction element set is suitable to discharge collected ash components from the element, specifically, but not exclusively, this being a flap and/or a rotary valve and/or a slide.

24. The construction element set according to claim 17 characterized in that the construction element set is suitable for creating a different degree of deposition in filters, specifically, but not exclusively, this being the integration of a gradient of the porosity across the channel length extent and/or the grading of the number and/or size of the filtration surface.

25. The construction element set according to claim 17 characterized in that the construction element set is suitable for controlling the volume flow across the inlet cross section, specifically, but not exclusively, this being the grading of the inflow channel cross sections and/or shape corresponding to requirements.

26. The construction element set according to claim 17 characterized in that the construction element set is suitable for minimizing the breakage occurring during assembly and simultaneously guaranteeing an increased stress absorption during operation, specifically, but not exclusively, this being material-related reinforcement of the outer wall of the element and/or the integration of stress-deflecting and/or stress-absorbing elements in the element scope.

27. The construction element set according to claim 17 characterized in that the construction element set is suitable, in the case of the filtration chamber, for arbitrarily selecting the inlet and/or outlet direction of the volume flows, specifically, but not exclusively, the individual filter channels of the outlet channels being combined into one or more collective outlet channels before these emerge from the filter element.

28. The construction element set according to claim 17 characterized in that the construction element set is suitable for increasing the wall contact of the volume flow, specifically, but not exclusively, this being attachment of contact strips and/or raised sections and/or increasing the surface roughness of the walls.

29. The construction element set according to claim 17 characterized in that the construction element set is suitable for increasing the maximum operating temperature of the product, specifically, but not exclusively, this being integration of stress-deflecting and/or stress-absorbing elements in and/or between the channel walls.

30. The construction element set according to claim 17 characterized in that the construction element set is suitable for intensifying the heat transfer between the substrate and volume flow, specifically, but not exclusively, this being surface enlargement across the minimum active distance that is here significantly shortened in relation to other component lengths.

31. The construction element set according to claim 17 characterized in that the construction element set is suitable for generating a temperature homogenization in the volume flow across the system cross section, specifically, but not exclusively, this being construction with different flow cross sections within a channel, but advantageously constructed not exclusively at corners.

32. The construction element set according to claim 17 characterized in that the construction element set is suitable for improving the heat transfer properties, specifically, but not exclusively, this being distribution of flow channel walls that lead to a compression of the volume flow and thus swirling and/or through openings of small channels into larger channels, wherein breakaway edges that lead to swirling and thus to increased energy transfer are produced at the ends of the small channels to which no wall of a larger channel is to be provided.

33. The construction element set according to claim 17 characterized in that the construction element set is suitable for presenting a maximum absorber surface for smallest possible flow resistance, specifically, but not exclusively, this being construction of more or less round inlet openings that are provided with or without additional elements, such as shafts, in the wall and/or additional bars or other elements for increasing surface area.

34. The construction element set according to claim 17 characterized in that the construction element set is suitable for reducing the mounting surfaces and increasing the active surface, specifically, but not exclusively, this being achieved in that, for example, for the solar receiver, the reaction surface equals at least 100 cm², which is realized through the integration of stress-deflecting and/or stress-absorbing elements in the channel structure.

35. The construction element set according to claim 17 characterized in that the construction element set is suitable for improving the heat transfer within the material structure without reducing the porosity of the material, specifically, but not exclusively, this being achieved by increasing the crystal transition surfaces for porous materials in the crystalline composite of the crystals among each other.

36. The construction element set according to claim 17 characterized in that the construction element set is suitable for creating different properties within one component also made from different materials, specifically, but not exclusively, this being caused by close packing of the differently acting individual elements into one package, where materials such as ceramic and/or metal and/or plastic can be combined with each other or can appear alone.

37. The construction element set according to claim 17 characterized in that the construction element set is suitable for exhibiting the same behavior as the adjacent part, this being specifically, but not exclusively, in particular, in joining technology, the use of the same materials for adjacent parts, in particular, in this way a seal is made from the same material as the parts to be sealed.

38. The construction element set according to claim 17 characterized in that the construction element set is suitable for taking over mechanical functions, specifically, but not exclusively, in the case of seals, this being integration of chambers within the sealing material that have a construction that can be compressed and/or expanded.

39. The construction element set according to claim 17 characterized in that the construction element set is suitable for ruling out a risk of functional leakage, specifically, but not exclusively, this being a seamless hollow chamber seal advantageously, but not exclusively, made from the same material as the components to be joined.

40. A construction element set made from a combination of at least two construction elements, each of which according to claim 1.

41. A product that comprises at least one construction element according to claim 1, wherein the at least one construction element is one or more of a diesel soot particulate filter, catalytic converter, solar receiver, and sealing element.
